(19) United States
(12) Patent Application Publication
(10) Pub. No.: US 2015/0218433 A1
(43) Pub. Date: Aug. 6, 2015

(54) Lubricant Additives for Wellbore or Subterranean Drilling Fluids or Muds

(71) Applicant: Dover Chemical Corporation, Dover, OH (US)

(72) Inventors: Duong Nguyen, Dover, OH (US); Don Stevenson, Dover, OH (US); Ben Rohr, Bolivar, OH (US)

(21) Appl. No.: 14/614,068

(22) Filed: Feb. 4, 2015

Related U.S. Application Data
(60) Provisional application No. 61/935,446, filed on Feb. 4, 2014.

(51) Int. Cl. C09K 8/34; E21B 7/00

(52) U.S. Cl. CPC C09K 8/34; E21B 7/00; C09K 2208/28; C09K 2208/34

(57) ABSTRACT

A drilling-fluid composition having an oil-based mud, water-based mud, or synthetic-based mud; and a fluid lubricant having a pour point ranging from −5° C. to −30° C., the fluid lubricant having a sulfurized fatty ester, a sulfurized olefin, or a combination thereof, wherein the sulfurized fatty ester is 5 to 15% by weight sulfur and selected from the group consisting of sulfurized biodiesel; sulfurized methyl oleate, and sulfurized methyl esters derived from vegetable oil, wherein the sulfurized olefin is 5 to 15% by weight sulfur and selected from the group consisting of sulfurized alpha or internal olefins ranging from C8 to C18; and the fluid lubricant being present in the composition in an amount ranging from 0.1 to 10% by weight.

### CROSS REFERENCE TO RELATED APPLICATIONS

This utility patent application claims priority to U.S. provisional patent application Ser. No. 61/935,446 having a filing date of Feb. 4, 2014. The provisional patent application's subject matter is hereby incorporated by reference into this application.

### BACKGROUND OF THE INVENTION

During drilling operations for oil and gas explorations, a drilling fluid or mud is typically circulated through the wellbore to facilitate the drilling process. This shortens the drilling time by lubricating the rotary drill bits that are located at the end of drill pipe string, and also by lubricating the drill pipe string that can stick or rub against the borehole causing undesirable increased friction, energy loss, misdirection of the drilling, and eventually slowing down the drilling process. The drilling mud is also designed to carry out cuttings or debris generated by drilling and to stabilize the well bore formation, preventing it from collapsing by its hydrostatic pressure exerted on the well-bore walls to maintain their integrity.

Drilling muds can be categorized according to their base: water-based muds (WBM) or oil-based muds (OBM). WBM typically include bentonite clay or polymeric (solids-free) thickeners to suspend or thicken the aqueous continuous phase which can be derived from fresh water or salt solutions (or brines) as in brine muds (BRM). OBM or invert-emulsion water-in-oil mud consist of 50:50 to 95:5 blend ratios of oil to water in which oil is the continuous phase. The continuous hydrocarbon phase in OBM can be diesel, mineral oil, natural vegetable oils, synthetic esters, or olefins.

In addition to their respective base, the commonly used components of both WBM and OBM include:
(a) Bentonite clay thickener for WBM or organophilic clay for OBM;
(b) Fluid-loss reducers or filtrate reducers that are typically water-dispersible polymers designed to stop the water component of a mud from penetrating into the drier surroundings of a well bore or vice versa, i.e., to stop subterranean water from penetrating into the well bore or newly-drilled formation by softening and collapsing it—these additives are also used to prevent water from diffusing into the drilling mud and altering its physical characteristics and therefore its designed functions—illustrative non-limiting examples of these additives illustrated herein are Baker Hughes' Xanplex® D or xanthan gum, Drilling Specialties Company's Drispac® Superflow or polyanionic cellulosic polymer, and Baker Hughes' Bio-Lose® or non-fermented chemically-modified starch;
(c) Thinners or deflocculants, a non-limiting exemplary list including Drilling Specialties' Desco® deflocculant which is a tannin-based thinner;
(d) Barite or barium sulfate, one of the more effective weighting materials to increase the drilling mud density; and consequently, to improve the mud's effective hydrostatic pressure underground;
(e) Rev-Dust®, manufactured by Milwhite Inc., an abrasive calcium montmorillonite commonly used to simulate effects of reactive drilled solids or cuttings;
(f) pH adjusters and other inorganic components such as sodium hydroxide or caustic, sodium chloride salt, lime, hydrated calcium chloride in brine;
(g) Amine or sodium alkylated sulfonates which are used as water-in-oil emulsifiers in OBM Formulas—for the purposes of examples contained later in this application, this component will be excluded to isolate the lubricity of the novel additive alone without taking into the beneficial or synergistic effect of a sulfonate emulsifier; and
(h) Lubricants—this additive class can be fatty acid, fatty amides and esters, phosphates, sulfurized, and chlorinated hydrocarbons—the lubricants are added into drilling fluids to reduce friction or torque, and consequently, to speed up the drilling rate with much less energy and time being consumed—fatty esters and amides also have a significant advantage by being a renewable, non-toxic, biodegradable, and environment-friendly friction reducers.

Some exemplary publications dealing with the use of fatty esters as the lubricant in drilling muds are illustrated in U.S. Pat. Nos. 4,964,615; 5,318,956; and 5,618,780; as well as in published United States Patent Application No. 2010/0305009 A1; and also in published PCT Patent Application No. WO 2011/019722 A2. The teachings of these publications are hereby incorporated by reference.

### BRIEF SUMMARY OF THE INVENTION

A drilling-fluid composition having an oil-based mud, water-based mud, or synthetic-based mud; and a fluid lubricant having a pour point ranging from −5° C. to −30° C., the fluid lubricant having a sulfurized fatty ester, a sulfurized olefin, or a combination thereof, wherein the sulfurized fatty ester is 5 to 15% by weight sulfur and selected from the group consisting of sulfurized biodiesel; sulfurized methyl oleate, and sulfurized methyl esters derived from vegetable oil, wherein the sulfurized olefin is 5 to 15% by weight sulfur and selected from the group consisting of sulfurized alpha or internal olefins ranging from C8 to C18; and the fluid lubricant being present in the composition in an amount ranging from 0.1 to 10% by weight.

A drilling-fluid composition having a fluid lubricant having a pour point ranging from −5° C. to −30° C., the fluid lubricant having a sulfurized fatty ester, a sulfurized olefin, or a combination thereof, wherein the sulfurized fatty ester is 5 to 15% by weight sulfur and selected from the group consisting of sulfurized biodiesel; sulfurized methyl oleate, and sulfurized methyl esters derived from vegetable oil, and wherein the sulfurized olefin is 5 to 15% by weight sulfur and selected from the group consisting of sulfurized alpha or internal olefins ranging from C8 to C18.

A subterranean-drilling method having the steps of performing subterranean drilling using a fluid lubricant having a pour point ranging from −5° C. to −30° C., the fluid lubricant having a sulfurized fatty ester, a sulfurized olefin, or a combination thereof, wherein the sulfurized fatty ester is 5 to 15% by weight sulfur and selected from the group consisting of sulfurized biodiesel; sulfurized methyl oleate, and sulfurized methyl esters derived from vegetable oil, wherein the sulfurized olefin is 5 to 15% by weight sulfur and selected from the group consisting of sulfurized alpha or internal olefins ranging from C8 to C18.

### DETAILED DESCRIPTION OF THE INVENTION

The examples and following embodiments are illustrative only and not meant to limit the inventive embodiments.

In embodiments, the fluid lubricant can be used at 0.1-10 wt % based on total weight of drilling fluids. In the experimental work described herein, the drilling fluids are tested at approximately 1 weight percent (wt %).

In embodiments, the sulfurized fatty ester illustrated in this invention is 10% S sulfurized biodiesel or methyl oleate or methyl esters derived from vegetable oils.

In embodiments, fatty esters that can be used to generate the novel lubricant additives of the topic of this invention can be any fatty esters such as all condensation products between polyols and carboxylic acids which include all well-known fatty acids such as stearic acid, lauric acid, oleic acid, linoleic acid, ricinoleic acid, dimer acid, and tall oil fatty acid.

In embodiments, olefins that can be used to generate the novel lubricant additives of the topic of this invention can be any alpha or internal olefins ranging from C8 to C24, can be branched or linear or blends thereof.

Blends of the above-mentioned fatty esters and olefins can be used to generate fluid-lubricant embodiments; and often it is the necessity to utilize such a blend of fatty esters and olefins to achieve a minus −20 C pour point that is the minimal pour point for the novel sulfurized lubricants to be poured out from the drums during the winter months in north Dakota, Ohio, or Pennsylvania.

In embodiments, the standard sulfurization process can be described ad follows: 10% sulfur flour is charged along with 90% fatty esters or olefins, or their blends into the 4-necked round bottom flask which is equipped with a thermometer, a nitrogen sparger, a mechanical stirrer, and a off-gas outlet which leads to the caustic solution scrubber. The reaction temperature is slowly raised to 165 C and an exotherm will take place to push the reacting temperature to 185-200 C. Allow the batch to cool down to 175 C, cook for two more hours, then cool the batch to 100 C before air blowing for two hours.

### DESCRIPTION OF EXPERIMENTAL LUBRICANT ADDITIVES

### Example #1

10.0 g sulfur flour and 90.0 g biodiesel or methyl esters of vegetable oils are allowed to react according to the standard sulfurization which is described in the last full paragraph of immediately above page 4.

### Example #2

10.0 g sulfur flour and 90.0 g 1-dodecene or C12 alpha olefin are allowed to react according to the standard sulfurization which is described in the last full paragraph of immediately above page 4.

### Example #3

10.0 g sulfur flour, 54.0 g 1-decene or alpha C10 olefin, and 36.0 g biodiesel or methyl esters of vegetable oils are allowed to react according to the standard sulfurization which is described in the last full paragraph of immediately above page 4.

### Example #4

10.0 g sulfur flour, 54.0 g 2-nonene, and 36.0 g biodiesel or methyl esters of vegetable oils are allowed to react according to the standard sulfurization which is described in the last full paragraph of immediately above page 4.

### List of Tested Lubricant Additives

TABLE I
Tested Lubricant Additives

| | |
|---|---|
| Lubricant 1 | Sulfurized methyl fatty esters, described in Example 1 |
| Lubricant 2 | Sulfurized C12 alpha olefin, described in Example 2 |
| Lubricant 3 | Sulfurized 60/40 blend of C10 alpha olefin and methyl |
| | fatty esters, described in Example 3 |
| Lubricant 4 | Sulfurized 60/40 blend of C9 2-nonenes and methyl |
| | fatty esters, described in Example 4 |

### DESCRIPTION OF DRILLING MUD TYPES

TABLE II
Water-Based Mud (WBM) compositions

| | WBM | |
|---|---|---|
| Components | (fresh water) | |
| Tap water | 350 | g |
| Bentonite | 25.0 | g |
| Organophilic clay | 0 | g |
| Xanplex ® D | 0.5 | g |
| Drispac ® Superflow | 0.5 | g |
| Desco ® Deflocculant | 0.5 | g |
| Barite | 0 | g |
| NaOH beads | 0.5 | g |
| NaCl salt | 0 | g |
| Lime | 0 | g |
| CaCl₂ hydrate | 0 | g |
| Rev-Dust ® | 0 | g |
| C₁₀ olefin | 0 | g |
| Novel Lubricant (1) | 4.0 | g |

| | |
|---|---|
| Oil/water ratio (OBM) | N/A |

Note:
(1) The novel lubricants are tested at approximately 1 wt %.

The oil-based drilling fluid or oil-based mud (OBM) used in illustrated the usefulness and novelty of the patentable lubricant is a fresh sample of a commercial product made with diesel as its base carrier.

The synthetic-based drilling fluid or synthetic-based mud (SBM) used in illustrated the usefulness and novelty of the patentable lubricant is a fresh sample of a commercial product made with synthetic oligomers or polymers of short chained olefins as its base carrier.

The SBM drilling fluids are more and more acceptable and preferred over its OBM or diesel counterpart due to the increasing environmental concerns over the toxicity and biodegradability of spilled muds into waterways and environment which surround oil rigs.

### List of Tested Lubricant Additives—Testing Methodology

The friction or friction reduction in percents of all experimental drilling muds as prepared by the above Table I were measured using an EP/lubricity tester such as Fann EP/Lubricity Tester which is the standard instrument in the field of oil and gas exploration. During this test, a hardened steel block rubs against a steel O-ring or cup while being submerged in the tested drilling fluid. A load is applied on the steel block transmitting to the steel ring by applying a constant load of 150 lbs using a lever arm which “squeezes” the steel block and the steel cup that rotates at the speed of 60 rpm. The torque in lb-in was recorded on a digital dial, and friction reduction was calculated based on the torques obtained with a blank mud which contains no lubricant and the one obtained with the same mud containing 2% of the novel lubricants. The generated data supporting a basis for the novelty of this invention is tabulated below in Table III.

### Testing Results

TABLE III
Testing Results: Pour points of the Pure Lubricants and % Friction or
Torque Reductions based 1 wt % lubricant used in drilling muds and
Ofite Lubricity Test run at 150 lb-load and 60 rpm condition:

| | Pour | Friction Reduction % | | |
|---|---|---|---|---|
| | points, | in | in | in |
| Lubricant | C. | WBM | OBM | SBM |
| Lubricant 1, 10% S methyl esters | 5 C. | 44 | 12 | 57 |
| Lubricant 2, 10% S C12 olefin | −22 C. | 45 | 12 | 62 |
| Lubricant 3, 10% S methyl esters & C12 | −21 C. | 52 | 17 | 59 |
| Lubricant 4, 10% S methyl esters & C9 | −25 C. | 50 | 19 | 61 |

Thus, the novel lubricants did demonstrate strongly their friction reduction capabilities in various types of drilling fluids and below −20 C pour points.

The examples are illustrative only and not meant to limit the invention, as measured by the scope and merit of the claims. The invention has been described with reference to preferred and alternate embodiments. Modifications and alterations will occur to others upon the reading and understanding of the specification. It is intended to include all such modifications and alterations insofar as they come within the scope of the appended claims or the equivalents thereof.

What is claimed is:

1. A drilling-fluid composition comprising:
an oil-based mud, water-based mud, or synthetic-based mud; and
a fluid lubricant having a pour point ranging from −5° C. to −30° C.,
the fluid lubricant having a sulfurized fatty ester, a sulfurized olefin, or a combination thereof,
wherein the sulfurized fatty ester is 5 to 15% by weight sulfur and selected from the group consisting of sulfurized biodiesel; sulfurized methyl oleate, and sulfurized methyl esters derived from vegetable oil,
wherein the sulfurized olefin is 5 to 15% by weight sulfur and selected from the group consisting of sulfurized alpha or internal olefins ranging from C8 to C18; and
the fluid lubricant being present in the composition in an amount ranging from 0.1 to 10% by weight.

2. The composition of claim 1, wherein the pour point ranges from −10° C. to −25° C.

3. The composition of claim 1, wherein the pour point is approximately −20° C.

4. The composition of claim 1, wherein the fluid lubricant has both a sulfurized fatty ester and a sulfurized olefin.

5. The composition of claim 4, wherein the fluid lubricant is 60% by weight sulfurized olefin.

6. The composition of claim 1, wherein the mud is an oil-based mud.

7. The composition of claim 1, wherein the mud is a water-based mud.

8. The composition of claim 1, wherein the mud is a synthetic-based mud.

9. A drilling-fluid composition comprising:
a fluid lubricant having a pour point ranging from −5° C. to −30° C.,
the fluid lubricant having a sulfurized fatty ester, a sulfurized olefin, or a combination thereof,
wherein the sulfurized fatty ester is 5 to 15% by weight sulfur and selected from the group consisting of sulfurized biodiesel; sulfurized methyl oleate, and sulfurized methyl esters derived from vegetable oil, and
wherein the sulfurized olefin is 5 to 15% by weight sulfur and selected from the group consisting of sulfurized alpha or internal olefins ranging from C8 to C18.

10. The composition of claim 9, further comprising an oil-based mud, water-based mud, or synthetic-based mud.

11. The composition of claim 10, wherein the fluid lubricant is present in the composition in an amount ranging from 0.1 to 10% by weight.

12. The composition of claim 9, wherein the pour point ranges from −10° C. to −25° C.

13. The composition of claim 9, wherein the pour point is approximately −20° C.

14. The composition of claim 9, wherein the fluid lubricant has a both a sulfurized fatty ester and a sulfurized olefin.

15. The composition of claim 9, wherein the fluid lubricant is about 60% by weight sulfurized olefin.

16. A subterranean-drilling method comprising the steps:
performing subterranean drilling using a fluid lubricant having a pour point ranging from −5° C. to −30° C.,
the fluid lubricant having a sulfurized fatty ester, a sulfurized olefin, or a combination thereof,
wherein the sulfurized fatty ester is 5 to 15% by weight sulfur and selected from the group consisting of sulfurized biodiesel; sulfurized methyl oleate, and sulfurized methyl esters derived from vegetable oil,
wherein the sulfurized olefin is 5 to 15% by weight sulfur and selected from the group consisting of sulfurized alpha or internal olefins ranging from C8 to C18.

17. The method of claim 16, further comprising the step of using the fluid lubricant in combination with a drilling mud in an amount ranging from 0.1 to 10% by weight.

18. The method of claim 16, wherein the fluid lubricant has both a sulfurized fatty ester and a sulfurized olefin.

19. The composition of claim 18, wherein the fluid lubricant is 60% by weight sulfurized olefin.

20. The composition of claim 16, wherein the pour point ranges from −10° C. to −25° C.
